(19) United States
(12) Patent Application Publication
(10) Pub. No.: US 2003/0050031 A1
(43) Pub. Date: Mar. 13, 2003

(54) Frequency conversion circuit having suppressed beat

(75) Inventors: Takeo Suzuki, Fukushima-ken (JP); Shoichi Asano, Fukushima-ken (JP); Toru Izumiyama, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/230,784

(22) Filed: Aug. 28, 2002

(30) Foreign Application Priority Data
Sep. 5, 2001 (JP) 2001-268902

(51) Int. Cl. H04B 1/26; H04B 1/06; H04B 7/00

(52) U.S. Cl. 455/265; 455/196.1; 455/255; 455/318

(57) ABSTRACT

A frequency conversion circuit includes a first mixer for performing frequency conversion of a received signal having components disposed at first frequency intervals into a first intermediate frequency signal which has a frequency lower than that of the received signal and which has components disposed at predetermined frequency intervals, two second mixers for performing frequency conversion of the first intermediate frequency signal into a second intermediate frequency signal having a frequency lower than that of the first intermediate frequency signal. A first local oscillation signal changing at second frequency intervals different from the first frequency intervals is supplied to the firs mixer, and a second local oscillation signal having a frequency which is the reciprocal of an integer of the frequency of the first local oscillation signal is supplied to the second mixers.

### BACKGROUND OF THE INVENTION

1. Field of the Invention

The present invention relates to a frequency conversion circuit suitable for use in a transceiver employing the next-generation 5-GHz mobile communication system called the “Multimedia Mobile Access Communication System (MMAC)”

2. Description of the Related Art

A common frequency conversion circuit of the prior art is shown in FIG. 6. An input/output end of a switching device 31 is connected to an antenna (not shown), and a frequency conversion circuit 32 in a receiver circuit is connected to the output end of the switching device 31. A received signal RX is input to a low noise amplifier 32a in the frequency conversion circuit 32. A first mixer 32b is connected in the next stage to the low noise amplifier 32a, and a first local oscillation signal L1 is supplied from a first local oscillator 32c to the first mixer 32b. An intermediate frequency amplifier 32d is connected in the next stage to the first local oscillator 32b, and a second mixer 32e is connected in the next stage to the intermediate frequency amplifier 32d. A second local oscillation signal L2 is supplied from the second local oscillator 32f to the second mixer 32e.

In addition, a frequency conversion circuit 33 in a transmitter circuit is connected to the input end of the switching device 31. A second intermediate frequency signal IF2 on which a base-band signal to be transmitted is superimposed is input to a third mixer 33a in the frequency conversion circuit 33. A third local oscillation signal L3 is supplied from a third local oscillator 33b to the third mixer 33a. An intermediate frequency amplifier 33c is connected in the next stage to the third mixer 33a, and a fourth mixer 33d is connected in the next stage to the intermediate frequency amplifier 33c. A fourth local oscillation signal L4 is supplied from a fourth local oscillator 33e to the fourth mixer 33d. A power amplifier 33f is connected in the next stage to the fourth mixer 33d, and the output end of the power amplifier 33f is connected to the input end of the switching device 31.

In the above-described construction, as FIG. 7 shows, from the frequency spectrum between the received signal RX and the first local oscillation signal L1 which are input to the first mixer 32b, it is found that the received signal RX is lower and the first local oscillation signal L1 is higher. The frequency range of the received signal RX is equal to the frequency range of the first local oscillation signal L1, and the frequency of the first local oscillation signal L1 changes correspondingly to the frequency of the received signal RX. As shown in FIG. 7, the first intermediate frequency signal IF1 has a constant frequency because the first mixer 32 outputs the first intermediate frequency signal IF1, which is the difference in frequency between the received signal RX and the first local oscillation signal L1.

As shown in FIG. 7, the second local oscillation signal L2 supplied to the second mixer 32e has a frequency higher than that of the first intermediate frequency signal IF1, and the second mixer 32e outputs the second intermediate frequency signal IF2, which is the difference in frequency between the second local oscillation signal L2 and the first intermediate frequency signal IF1. The second intermediate frequency signal IF2 is processed by another circuit provided after the stage of the second mixer 32e.

In the transmitter circuit, the second intermediate frequency signal IF2 input to the third mixer 33a has a central frequency identical to that of a second intermediate frequency signal output from the second mixer 32e in the receiver circuit, and the third local oscillation signal L3 supplied to the third mixer 33a has a frequency identical to that of the second local oscillation signal L2. Accordingly, the third mixer 33a outputs the first intermediate frequency signal IF1. The fourth local oscillation signal L4 supplied to the fourth mixer 33d has a frequency identical to that of the first local oscillation signal L1. Accordingly, the fourth mixer 33d outputs a transmission signal TX having a frequency identical to that of the received signal RX. Therefore, the frequency spectrum of each portion of the frequency conversion circuit 33 in the transmitter circuit is as shown in FIG. 7.

In the above-described construction, the first local oscillation signal L1 and the fourth local oscillation signal L4 are identical in frequency range, and the second local oscillation signal L2 and the third local oscillation signal L3 are identical in frequency. Thus, one of the first local oscillator 32c and the fourth local oscillator 33e can be used in common, with the other one eliminated. In addition, one of the second local oscillator 32f and the third local oscillator 33b can be used in common, with the other one eliminated.

The structure of the frequency conversion circuit of the prior art causes beat interference between local oscillation signals because two local oscillators having different oscillation frequencies are used.

### SUMMARY OF THE INVENTION

It is an object of the present invention to prevent occurrence of beat interference caused by two local oscillation signals when frequency conversion is performed twice.

To this end, according to an aspect of the present invention, a frequency conversion circuit is provided which includes a first mixer for performing frequency conversion of a received signal which has components disposed at first frequency intervals into a first intermediate frequency signal having a frequency lower than that of the received signal, and which has components disposed at predetermined frequency intervals, second mixers for performing frequency conversion of the first intermediate frequency signal into a second intermediate frequency signal having a frequency lower than that of the first intermediate frequency signal. A first local oscillation signal changing at second frequency intervals different from the first frequency intervals is supplied to the first mixer, and a second local oscillation signal having a frequency which is the reciprocal of an integer of the frequency of the first local oscillation signal is supplied to the second mixers.

Preferably, the frequency conversion circuit further includes a local oscillator for supplying the first local oscillation signal to the first mixer. The second local oscillation signal is generated by performing frequency division on the first local oscillation signal.

The frequency of the first local oscillation signal may be set to be higher than that of the received signal, and the frequency division factor of the frequency division on the first local oscillation signal may be set to 6.

The frequency of the first local oscillation signal may be set to be lower than that of the received signal, and the frequency division factor of the frequency division on the first local oscillation signal may be set to 4.

The lowest central frequency of the received signal may be set to 5170 MHz, and the central frequency of the second intermediate frequency signal may be set to 20 MHz.

According to the present invention, the beat interference between two local oscillation signals is prevented from occurring.

Since frequency conversion is performed twice, the signal can be amplified by amplifiers in stages prior to the first and second mixers. Thus, the amplifiers can be prevented from abnormally oscillating, even if the signal is amplified to the required level.

According to the present invention, the frequency of the second local oscillation signal can easily be reduced to the reciprocal of an integer of the frequency of the first local oscillation signal.

According to the present invention, the local division factor can easily be set without setting the frequency of the first local oscillation signal not to be so high.

According to the present invention, the ratio of the image frequency to the received signal frequency is large. This is advantageous in coping with image interference.

According to the present invention, by setting the lowest central frequency of the received signal to 5170 MHz, and setting the central frequency of the baseband signal to 20 MHz, the endurance against image interference of the receiver unit of a transceiver using the 5-GHz band can be enhanced.

According to another aspect of the present invention, a frequency conversion circuit is provided which includes third mixers for performing frequency conversion of a second intermediate frequency signal into a first intermediate frequency signal which has a frequency higher than that of the second intermediate frequency signal and which has components disposed at one type of frequency intervals among plural types of predetermined frequency intervals, and a fourth mixer for performing frequency conversion of the first intermediate frequency signal into any one of transmission signals which each have a frequency higher than that of the first intermediate frequency signal and which each have components disposed at first frequency intervals. A first local oscillation signal changing at second frequency intervals different from the first frequency intervals is supplied to the fourth mixer, and a second local oscillation signal having a frequency which is the reciprocal of an integer of the first local oscillation signal is supplied to the third mixers.

Preferably, the frequency conversion circuit further includes a local oscillator for supplying the first local oscillation signal to the fourth mixer, and the second local oscillation signal is generated by performing the frequency division on the first local oscillation signal.

The frequency of the first local oscillation signal may be set to be higher than that of the transmission signal, and the frequency division factor of the frequency division on the first local oscillation signal may be set to 6.

The frequency of the first local oscillation signal may be set to be lower than that of the transmission signal, and the frequency division factor of the frequency division on the first local oscillation signal may be set to 4.

The lowest central frequency of the transmission signal may be set to 5170 MHz, and the central frequency of the second intermediate frequency signal may be set to 20 MHz.

The frequency of the second local oscillation signal may be set to be higher than that of the first intermediate frequency signal.

The frequency of the second local oscillation signal may be set to be higher than that of the first intermediate frequency signal.

The frequency of the second local oscillation signal may be set to be higher than that of the first intermediate frequency signal.

The frequency of the second local oscillation signal may be set to be higher than that of the first intermediate frequency signal.

According to the present invention, the beat interference between two local oscillation signals is prevented from occurring.

Since frequency conversion is performed twice, the signal can be amplified by amplifiers in stages prior to the first and third mixers. Thus, the amplifiers can be prevented from abnormally oscillating, even if the signal is amplified to the required level.

According to the present invention, the frequency of the second local oscillation signal can easily be reduced to the reciprocal of an integer of the frequency of the first local oscillation signal.

According to the present invention, the local division factor can easily be set without setting the frequency of the first local oscillation signal not to be so high.

According to the present invention, the ratio of the image frequency to the received signal frequency is large. This is advantageous in coping with image interference.

According to the present invention, by setting the lowest central frequency of the transmission signal to 5170 MHz, and setting the central frequency of the second intermediate frequency signal to 20 MHz, the endurance against image interference of the receiver unit of a transceiver using the 5-GHz band can be enhanced.

In addition, according to the present invention, the load on a mixer to which a first intermediate frequency signal is input can be reduced because the frequency of a second local oscillation signal is set to be higher than the frequency of the first intermediate frequency signal.

### BRIEF DESCRIPTION OF THE DRAWINGS

FIG. 1 is a transceiver block diagram illustrating a frequency conversion circuit of the present invention;

FIG. 2 is a first frequency spectrum graph illustrating the operation of the frequency conversion circuit shown in FIG. 1;

FIG. 3 is a second frequency spectrum graph illustrating the operation of the frequency conversion circuit shown in FIG. 1;

FIG. 4 is a third frequency spectrum graph illustrating the operation of the frequency conversion circuit shown in FIG. 1;

FIG. 5 is a fourth frequency spectrum graph illustrating the operation of the frequency conversion circuit shown in FIG. 1;

FIG. 6 is a circuit diagram of a transceiver which illustrates a frequency conversion circuit of the prior art; and

FIG. 7 is a frequency spectrum graph illustrating the operation of the frequency conversion circuit shown in FIG. 6.

### DESCRIPTION OF THE PREFERRED EMBODIMENTS

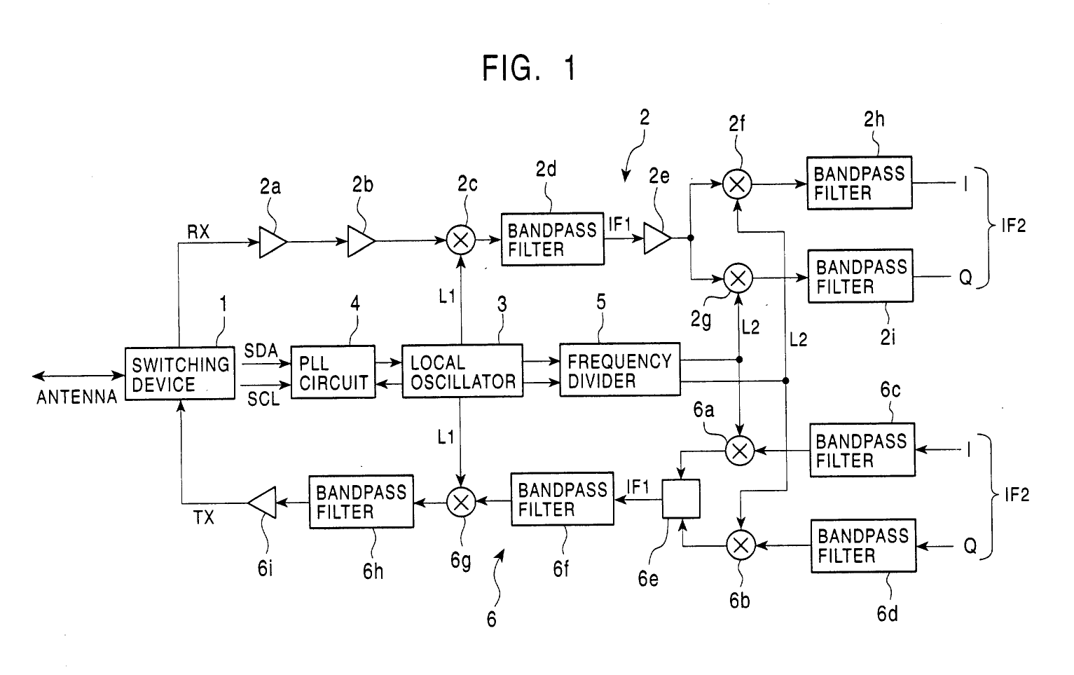

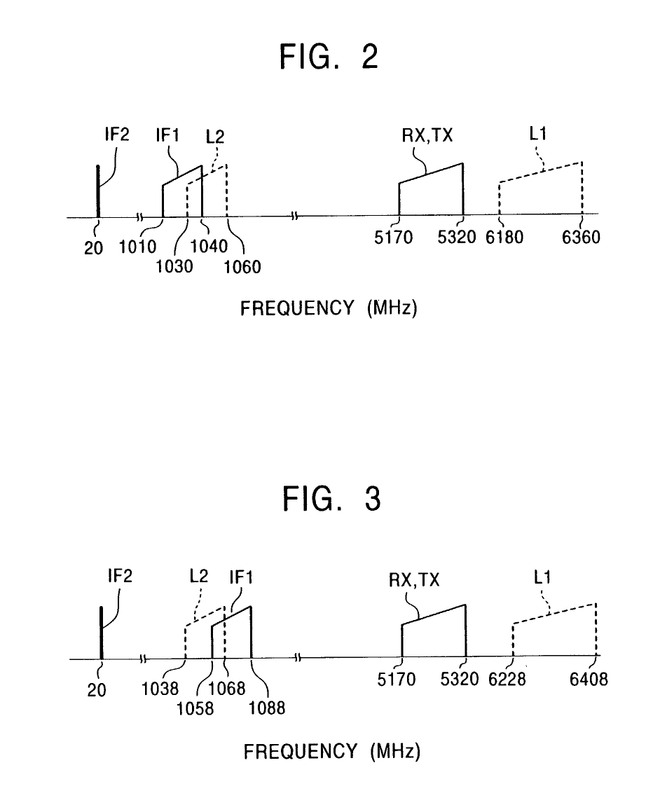

A frequency conversion circuit of the present invention is described below with reference to the accompanying drawings. FIG. 1 is a transceiver block diagram illustrating the frequency conversion circuit of the present invention. FIGS. 2 to 5 are frequency spectrum graphs illustrating operations.

Referring to FIG. 1, the input/output end of a switching device 1 is connected to an antenna (not shown), and a frequency conversion circuit 2 in a receiver circuit is connected to the output end of the switching device 1. A received signal RX is obtained by orthogonal frequency division multiplexing (OFDM) and has first frequency intervals each having 10 MHz. The received signal RX is amplified by two stages formed by low noise amplifiers 2a and 2b in the frequency conversion circuit 2. The frequency range of the signal received by each amplifier is approximately 20 MHz.

A first mixer 2c is connected in the next stage to the low noise amplifier 2b, and a first local oscillation signal L1 is supplied from a local oscillator 3 to the first mixer 2c. The frequency of the first local oscillation signal L1 changes at second frequency intervals correspondingly to the frequency of the received signal. However, the second frequency intervals differ from the first frequency intervals. The oscillation frequency of a local oscillator 3 is controlled by a phase-locked loop (PLL) circuit 4. Data SDA and a clock SCL for controlling the oscillation frequency are input to the PLL circuit 4.

A bandpass filter 2d and an intermediate frequency amplifier 2e are cascade-connected in the next state to the first mixer 2c. Two second mixers 2f and 2g are connected in parallel in the next stage to the intermediate frequency amplifier 2e. A second local oscillation signal L2 is supplied to the second mixers 2f and 2g. The second local oscillation signal L2 is generated by using a frequency divider 5 to perform frequency division on the first local oscillation signal L1 output from the local oscillator 3. Accordingly, the second local oscillation signal L2 changes at frequency intervals which are smaller than the second frequency intervals. In this case, the phases of the second local oscillation signal L2 supplied to the two second mixers 2f and 2g are orthogonal to each other (differ in 90 degrees).

Bandpass filters 2h and 2i are connected in the next stage to the second mixers 2f and 2g, respectively. Each of the bandpass filters 2h and 2i has a central passband frequency of approximately 10 to 25 MHz.

A frequency conversion circuit 6 in a transmitter circuit is connected to the input end of the switching device 1. Second intermediate frequency signals (I signal and Q signal the phases of which are orthogonal to each other) to be transmitted are input to two third mixers 6a and 6b in the frequency conversion circuit 6 through bandpass filters 6c and 6d connected to the third mixers 6a and 6b. The bandpass filters 6c and 6d are identical to the bandpass filters 2h and 2i in structure and characteristics. Second local oscillation signal L2 the phases of which are orthogonal to each other are supplied to the third mixers 6a and 6b. An adder 6e is connected in the next stage to the third mixers 6a and 6b. A bandpass filter 6f is connected to the adder 6e. The bandpass filter 6f is also identical to the bandpass filter 2d in structure and characteristics. A fourth mixer 6g is connected in the next stage to the bandpass filter 6f, and the first local oscillation signal L1 is supplied to the fourth mixer 6g.

A bandpass filter 6h and a power amplifier 6i are cascade-connected in the next stage to the fourth mixer 6g, and the output end of the power amplifier 6i is connected to the switching device 1.

In the above construction, the first mixer 2c outputs a first intermediate frequency signal IF1 that is the difference in frequency between the received signal RX and the first local oscillation signal L1. The second mixers 2f and 2g output second intermediate frequency signals IF2 (I signal and Q signal the phases of which are orthogonal to each other). Each of the second intermediate frequency signals IF2 is the difference in frequency between the first local oscillation signal L1 and the second local oscillation signal L2.

Here, assuming that the frequency of the received signal RX be R+kS_{R} (where R represents the central frequency of the lowest frequency band of the received signal RX, k represents a positive integer up to 15 including 0, and S_{R} represents the first frequency interval), the frequency of the first local oscillation signal L1 be L+kS_{L} (where L represents the lowest frequency of the first local oscillation signal L1 which corresponds to the received signal RX, and S_{L} represents the second frequency interval), the frequency division factor of the frequency divider 5 be N, and the central frequency of the second intermediate frequency signal IF2 be 12, the following expression holds:

$$\vert ( R - {kS}_{R} ) - ( L + {kS}_{L} ) \vert = \frac{L + {kS}_{L}}{N} \pm {I}_{2} \qquad ( 1 )$$

By substituting 0 and 1 for k in expression (1), two equations (not shown) are obtained. From the two equations, the lowest frequency L of the first local oscillation signal L1 and the frequency dividing factor N can be found.

First, in a first combination case in which the frequency of the first local oscillation signal L1 is set to be higher than that of the received signal RX, and the frequency of the second local oscillation signal L2 is set to be higher than that of the second local oscillation signal L2, the lowest frequency of the first local oscillation signal L1 and the frequency dividing factor N are as shown in the following expressions:

$$\begin{matrix}L = \frac{{S}_{L} ( R - {I}_{2} )}{{S}_{R}} & ( 2 ) \\ N = \frac{{S}_{L}}{{S}_{L} - {S}_{R}} & ( 3 )\end{matrix}$$

When specific values, R=5170, S_{R}=10, and I₂=20, in expressions (2) and (3), L=515S_{L}, and N=S_{L}/(S_{L}−10). Accordingly, the second frequency interval S_{L} is a value that is not less than 10, and the lowest frequency L of the first local oscillation signal L1 and the frequency dividing factor N can be found. For example, when the second frequency interval S_{L} is set to 11, 12, 15, and 20, the frequency dividing factor is 11, 6, 3, and 2, respectively, and the lowest frequency of the first local oscillation signal L1 is 5665, 6180, 7725, 10300 MHz, respectively. Nevertheless, from the stability of the oscillating frequency and ease of the frequency dividing factor N, it is preferable that the second frequency interval S_{L} be 12 MHz.

The frequency spectrum obtained when the second frequency interval S_{L} is set to 12 MHz is shown in FIG. 2. For a received signal changes at intervals of 10 MHz in the 150-MHz frequency range from 5170 MHz to 5320 MHz, the first local oscillation signal L1 changes at intervals of 12 MHz in the 180-MHz frequency range from 6180 MHz to 6360 MHz. The first intermediate frequency signal IF1 changes at intervals of 2 MHz in the 30-MHz frequency range from 1010 MHz to 1040 MHz.

Next, in a second combination case in which the frequency of the first local oscillation signal L1 is set to be higher than that of the received signal RX, and the frequency of the second local oscillation signal L2 is set to be lower than that of the first intermediate frequency signal IF1, the lowest frequency L of the first local oscillation signal L1 is as shown in the following expression. Expression (3) is unchanged and applied to the frequency dividing factor N.

$$L = \frac{{S}_{L} ( R - {I}_{2} )}{{S}_{R}} \qquad ( 4 )$$

Similarly, when the above specific values are used, L=519S_{L}, N=S_{L}/(S_{L}−10). Also in this case, the second frequency interval S_{L} is a value that is not less than 10, and the lowest frequency L of the first local oscillation signal L1 and the frequency dividing factor N can be found for the value of S_{L}. For example, when the second frequency interval S_{L} is set to 11, 12, 15, and 20, the lowest frequency of the first local oscillation signal L1 is 5709, 6228, 7785, and 10380 MHz, respectively. Nevertheless, from the stability of the oscillating frequency and ease of setting the frequency dividing factor N, it is preferable that the second frequency interval S_{L} be 12 MHz.

A frequency spectrum obtained when the second frequency interval S_{L} is set to 12 MHz is shown in FIG. 3. The first local oscillation signal L1 changes at intervals of 12 MHz in the 180-MHz frequency range from 6228 MHz to 6408 MHz. The first intermediate frequency signal IF1 changes at intervals of 2 MHz in the 30-MHz frequency range from 1058 MHz to 1088 MHz.

Next, in a third combination case in which the first local oscillation signal L1 is set to be lower than that of the received signal RX, and the frequency of the second local oscillation signal L2 is set to be higher than that of the first intermediate frequency signal IF1, the frequency dividing factor N is represented by the following expression, and expression (4) is applied to the lowest frequency of the first local oscillation signal L1.

$$N = \frac{{S}_{L}}{{S}_{R} - {S}_{L}} \qquad ( 5 )$$

When the above specific values are used, L=519S_{L}, and N=S_{L}/(10−S_{L}). In this case, the second frequency interval S_{L} is a value that is not greater than 10. For example, when the second frequency interval S_{L} is set to 9, 8, and 5, the frequency dividing factor N is 9, 4, and 1, respectively, and the lowest frequency of the first local oscillation signal L1 is 4671, 4152, and 2595 MHz, respectively. Nevertheless, from the stability of the oscillating frequency and ease of the frequency dividing factor N, it is preferable that the second frequency interval S_{L} be 8 MHz.

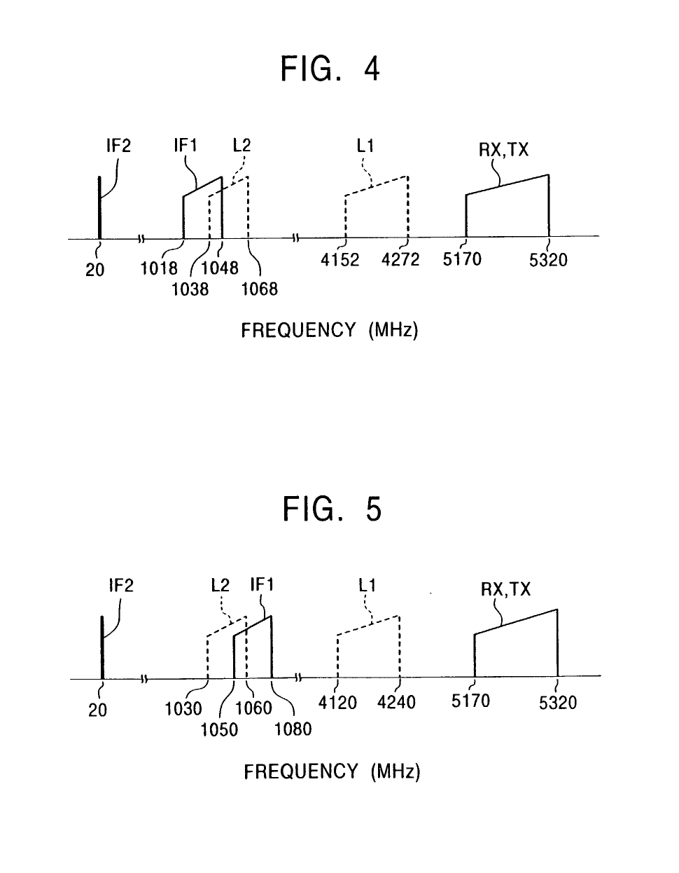

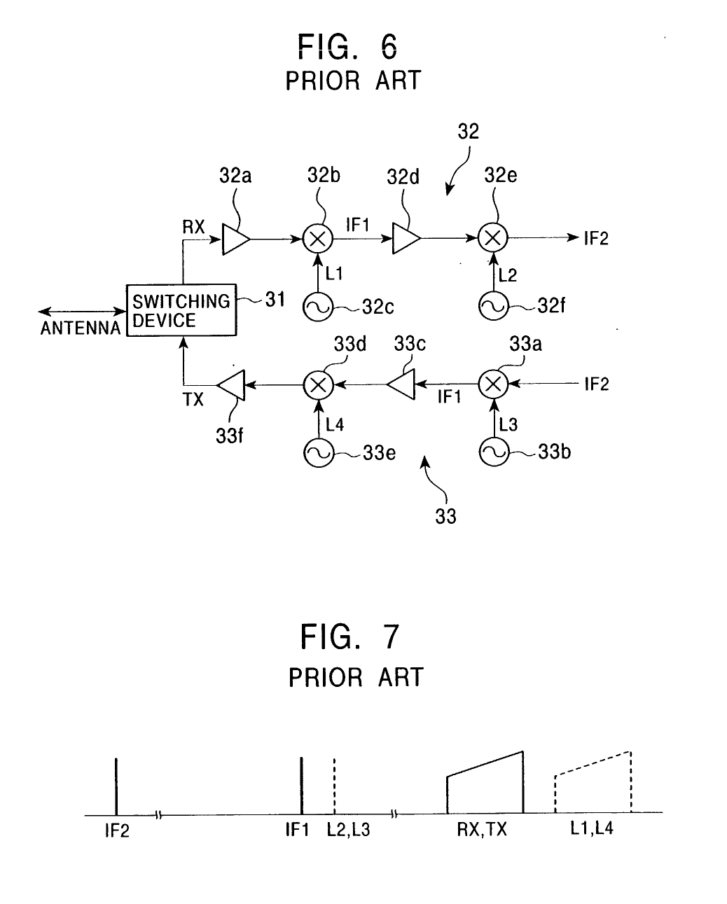

A frequency spectrum obtained when the second frequency interval S_{L} is set to 8 MHz is shown in FIG. 4. The first local oscillation signal L1 changes at intervals of 8 MHz in the 120-MHz frequency range from 4152 MHz to 4272 MHz. The first intermediate frequency signal IF1 changes at intervals of 2 MHz in the 30-MHz frequency range from 1018 MHz to 1048 MHz.

Finally, in a fourth combination case in which the frequency of the first local oscillation signal L1 is set to be lower than that of the received signal RX, and the frequency of the second local oscillation signal L2 is also set to be lower than that of the first intermediate frequency signal IF1, expression (2) is applied to the first local oscillation signal L1, and expression (5) is applied to the frequency dividing factor N.

When the specific values are used, L=515S_{L}, and N=S_{L}/(10−S_{L}). When the second frequency interval S_{L} is set to 9, 8, and 5, the frequency dividing factor N is 9, 4, and 1, respectively, and the lowest frequency L of the first local oscillation signal L1 is 4635 MHz, 4120 MHz, and 2575 MHz, respectively. Nevertheless, from the stability of the oscillating frequency and ease of the frequency dividing factor N, it is preferable that the second frequency interval S_{L} be 8 MHz.

A frequency spectrum obtained when the second frequency interval S_{L} is set to 8 MHz is shown in FIG. 5. The first local oscillation signal L1 changes at intervals of 8 MHz in the 120-MHz frequency range from 4120 MHz to 4240 MHz. The first intermediate frequency signal IF1 change at intervals of 2 MHz in the 30-MHz frequency range from 1050 MHz to 1080 MHz.

Among the above-described four cases, the third and fourth cases in which an image signal frequency is lower than the frequency of the received signal RX are advantageous in order to reduce image interference. From the perspective that there are small loads on the second mixers 2f and 2g because preferable band characteristics are obtained based on the low frequency of the first intermediate frequency signal IF1, the first and third cases are advantageous in that the second local oscillation signal L2 is higher than that of the first intermediate frequency signal IF1.

Next, the operation of the frequency conversion circuit 6 in the transmitter circuit is described below.

The two third mixers 6a and 6b output the first intermediate frequency signal IF1 which has the sum or difference in frequency between the input second intermediate frequency signal IF2 and the second local oscillation signal L2. The fourth mixer 6g outputs the transmission signal TX which has the sum or difference in frequency between the first intermediate frequency signal IF1 and the first local oscillation signal L1.

Also, in this case, expressions (1) to (5) are directly applied to frequency relationships among the signals, and the frequency band of the received signal RX and the frequency band of the transmission signal TX are similar to each other.

When the third mixers 6a and 6b output the first intermediate frequency signal IF1 which has the difference in frequency between the second intermediate frequency signal IF2 and the second local oscillation signal L2, and the fourth mixer 6g outputs the transmission signal TX which has the difference in frequency between the first intermediate frequency signal IF1 and the first local oscillation signal L1, the first case is applied.

In addition, when the third mixers 6a and 6b output the first intermediate frequency signal IF1 which has the sum in frequency between the second intermediate frequency signal IF2 and the second local oscillation signal L2, and the fourth mixer 6g outputs the transmission signal TX which has the difference in frequency between the first intermediate frequency signal IF1 and the first local oscillation signal L1, the second case is applied. When the third mixers 6a and 6b output the first intermediate frequency signal IF1 which has the difference in frequency between the second intermediate frequency signal IF2 and the second local oscillation signal L2, and the fourth mixer 6g outputs the transmission signal TX which has the sum in frequency between the first intermediate frequency signal IF1 and the first local oscillation signal L1, the third case is applied.

In addition, when the third mixers 6a and 6b output the first intermediate frequency signal IF1 which has the sum in frequency between the second intermediate frequency signal IF2 and the second local oscillation signal L2, and the fourth mixer 6g outputs the transmission signal TX which has the sum in frequency between the first intermediate frequency signal IF1 and the first local oscillation signal L1, the fourth case is applied.

What is claimed is:

1. A frequency conversion circuit comprising:
a first mixer for performing frequency conversion of a received signal having components disposed at first frequency intervals into a first intermediate frequency signal which has a frequency lower than that of the received signal, and which has components disposed at predetermined frequency intervals;
second mixers for performing frequency conversion of the first intermediate frequency signal into a second intermediate frequency signal having a frequency lower than that of the first intermediate frequency signal;
wherein:
a first local oscillation signal changing at second frequency intervals different from said first frequency intervals is supplied to said first mixer, and
a second local oscillation signal having a frequency which is the reciprocal of an integer of the frequency of the first local oscillation signal is supplied to said second mixers.

2. A frequency conversion circuit according to claim 1, further comprising a local oscillator for supplying the first local oscillation signal to said first mixer, wherein the second local oscillation signal is generated by performing frequency division on the first local oscillation signal.

3. A frequency conversion circuit according to claim 2, wherein the frequency of the first local oscillation signal is set to be higher than that of the received signal, and the frequency division factor of the frequency division on the first local oscillation signal is set to 6.

4. A frequency conversion circuit according to claim 2, wherein the frequency of the first local oscillation signal is set to be lower than that of the received signal, and the frequency division factor of the frequency division on the first local oscillation signal is set to 4.

5. A frequency conversion circuit according to claim 1, wherein the lowest central frequency of the received signal is set to 5170 MHz, and the central frequency of the second intermediate frequency signal is set to 20 MHz.

6. A frequency conversion circuit comprising:
third mixers for performing frequency conversion of a second intermediate frequency signal into a first intermediate frequency signal which has a frequency higher than that of the second intermediate frequency signal and which has components disposed at one type of frequency intervals among plural types of predetermined frequency intervals; and
a fourth mixer for performing frequency conversion of said first intermediate frequency signal into any one of transmission signals which each have a frequency higher than that of said first intermediate frequency signal and which each have components disposed at first frequency intervals;
wherein:
a first local oscillation signal changing at second frequency intervals different from the first frequency intervals is supplied to said fourth mixer; and
a second local oscillation signal having a frequency which is the reciprocal of an integer of the first local oscillation signal is supplied to said third mixers.

7. A frequency conversion circuit according to claim 6, further comprising a local oscillator for supplying the first local oscillation signal to said fourth mixer, wherein the second local oscillation signal is generated by performing the frequency division on the first local oscillation signal.

8. A frequency conversion circuit according to claim 7, wherein the frequency of the first local oscillation signal is set to be higher than that of the transmission signal, and the frequency division factor of the frequency division on the first local oscillation signal is set to 6.

9. A frequency conversion circuit according to claim 7, wherein the frequency of the first local oscillation signal is set to be lower than that of the transmission signal, and the frequency division factor of the frequency division on the first local oscillation signal is set to 4.

10. A frequency conversion circuit according to claim 6, wherein the lowest central frequency of the transmission signal is set to 5170 MHz, and the central frequency of the second intermediate frequency signal is set to 20 MHz.

11. A frequency conversion circuit according to claim 4, wherein the frequency of the second local oscillation signal is set to be higher than that of said first intermediate frequency signal.

12. A frequency conversion circuit according to claim 5, wherein the frequency of the second local oscillation signal is set to be higher than that of said first intermediate frequency signal.

13. A frequency conversion circuit according to claim 9, wherein the frequency of the second local oscillation signal is set to be higher than that of said first intermediate frequency signal.

14. A frequency conversion circuit according to claim 10, wherein the frequency of the second local oscillation signal is set to be higher than that of said first intermediate frequency signal.
